(19) United States
(12) Patent Application Publication
(10) Pub. No.: US 2022/0349625 A1
(43) Pub. Date: Nov. 3, 2022

(54) Sunlight Reflecting Assembly

(71) Applicant: Bruce Kindberg, Visalia, CA (US)

(72) Inventor: Bruce Kindberg, Visalia, CA (US)

(21) Appl. No.: 17/244,107

(22) Filed: Apr. 29, 2021

(51) Int. Cl. F24S 23/79; F24S 23/77; F24S 23/30

(52) U.S. Cl. CPC F24S 23/79; F24S 23/77; F24S 23/30

(57) ABSTRACT

A sunlight reflecting assembly includes a box that has an entry and an exit. The exit is oriented at a substantially diagonal angle with the entry and the box is positionable outdoors such that sunlight passes through the entry. A first mirror is positioned within the box and the first mirror is comprised of a light reflecting material to reflect the sunlight that passes into the box. A second mirror is positioned within the box and the second mirror is comprised of a light reflecting material to reflect the sunlight that passes into the box. The second mirror is positioned on an opposite side of the box with respect to the first mirror. In this way the first mirror and the second mirror direct the sunlight that passes into the entry outwardly through the exit thereby facilitating the sunlight which passes through the exit to be directed toward a solar panel.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to reflecting devices and more particularly pertains to a new reflecting device for collecting and reflecting sunlight onto a solar panel. The device includes a box with a sloped entry for collecting sunlight and an angled exit for directing the sunlight in a preferred direction. A pair of mirrors is positioned with the box and the mirrors are positioned opposite each other for reflecting the sunlight outwardly through the angled exit and onto a solar panel that would otherwise be obstructed from sunlight.

### (2) Description of Related Art Including Information Disclosed Under 37 CFR 1.97 and 1.98

The prior art relates to reflecting devices including a variety of refraction devices that include refraction prisms for directing sunlight in a preferred direction. The prior art also discloses a solar concentrator for focusing sunlight into a plurality of collimated beams that can be directed in preferred direction. The prior art discloses a sunlight modulation device for focusing and deflecting sunlight in order to separate focused sunlight from diffuse sunlight. The prior art discloses a solar concentrator that includes a primary mirror, a secondary mirror and a concavely arcuate heat shield.

### BRIEF SUMMARY OF THE INVENTION

An embodiment of the disclosure meets the needs presented above by generally comprising a box that has an entry and an exit. The exit is oriented at a substantially diagonal angle with the entry and the box is positionable outdoors such that sunlight passes through the entry. A first mirror is positioned within the box and the first mirror is comprised of a light reflecting material to reflect the sunlight that passes into the box. A second mirror is positioned within the box and the second mirror is comprised of a light reflecting material to reflect the sunlight that passes into the box. The second mirror is positioned on an opposite side of the box with respect to the first mirror. In this way the first mirror and the second mirror direct the sunlight that passes into the entry outwardly through the exit thereby facilitating the sunlight which passes through the exit to be directed toward a solar panel.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a perspective view of a sunlight reflecting assembly according to an embodiment of the disclosure.

FIG. 2 is a front phantom view of an embodiment of the disclosure.

FIG. 3 is a left side phantom view of an embodiment of the disclosure.

FIG. 4 is a back phantom view of an embodiment of the disclosure.

FIG. 5 is a perspective in-use view of an embodiment of the disclosure.

FIG. 6 is a perspective in-use view of an alternative embodiment of the disclosure.

### DETAILED DESCRIPTION OF THE INVENTION

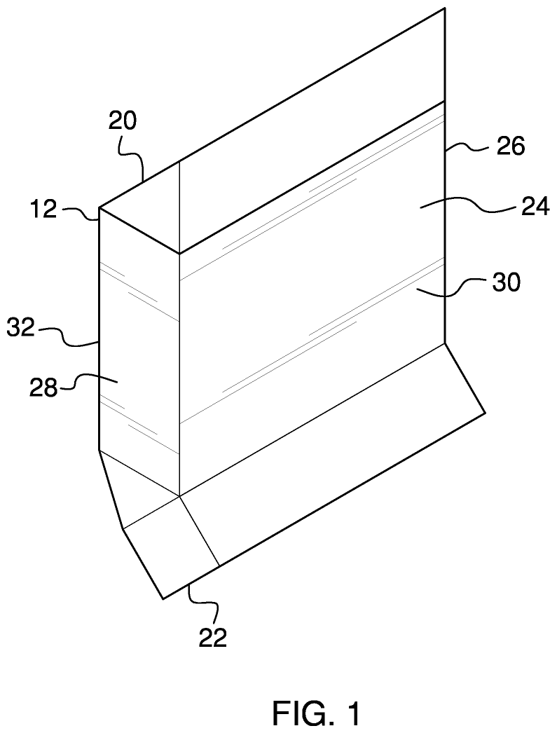

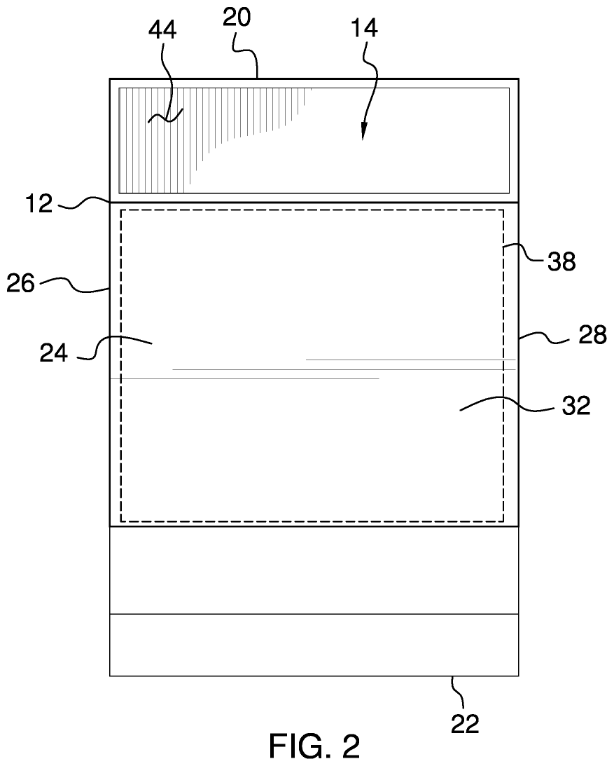

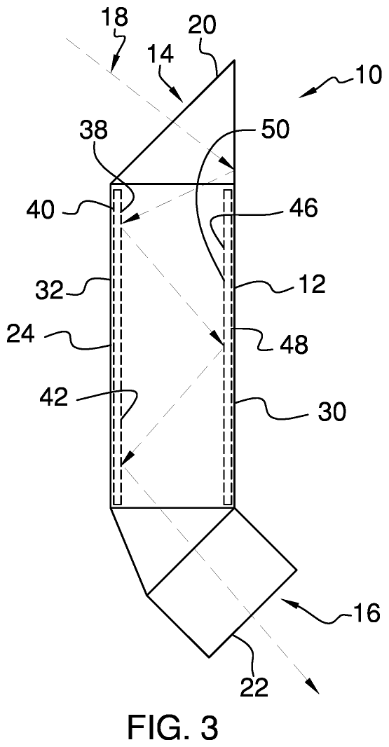

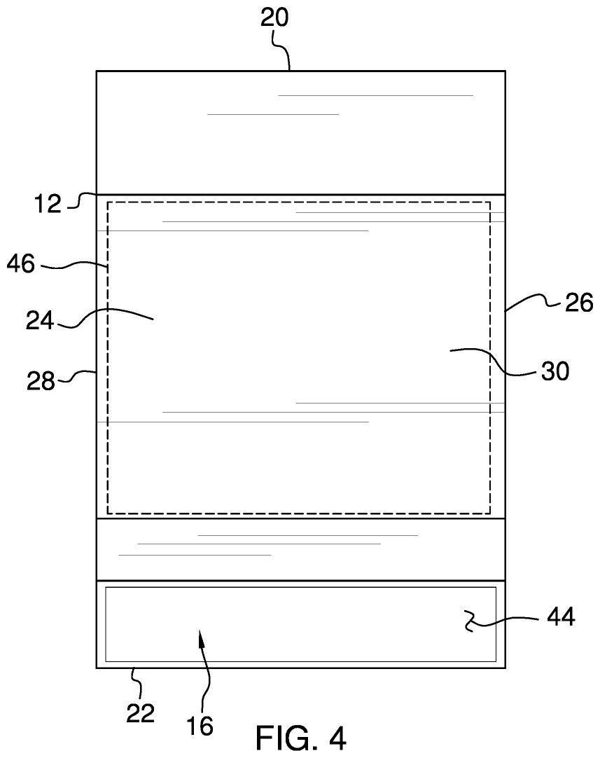

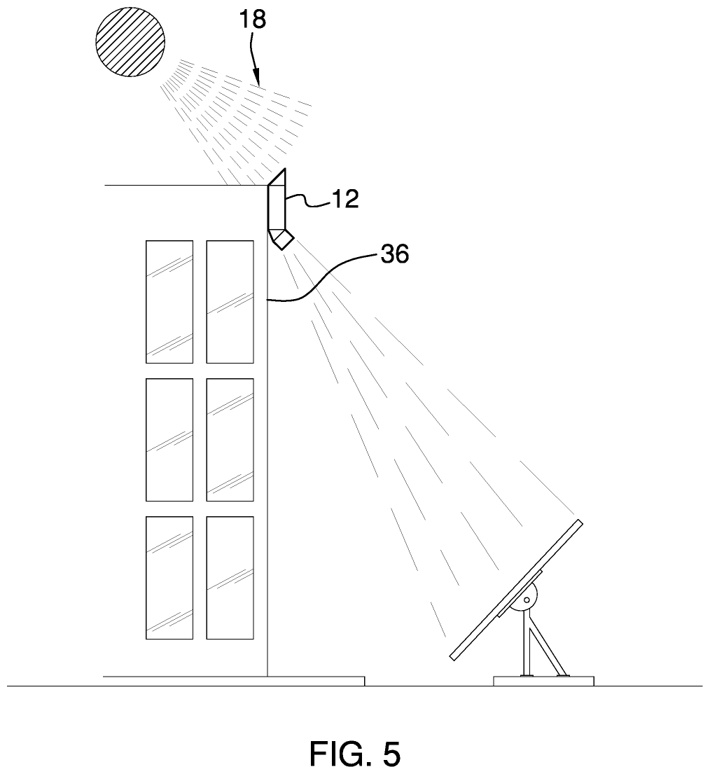

With reference now to the drawings, and in particular to FIGS. 1 through 6 thereof, a new reflecting device embodying the principles and concepts of an embodiment of the disclosure and generally designated by the reference numeral 10 will be described.

As best illustrated in FIGS. 1 through 6, the sunlight reflecting assembly 10 generally comprises a box 12 that has an entry 14 and an exit 16, and the exit 16 is oriented at a substantially diagonal angle with the entry 14. The box 12 is positionable outdoors to facilitate sunlight 18 to pass into the entry 14. The box 12 has a top end 20, a bottom end 22 and an outer wall 24 extending between the top end 20 and the bottom end 22, and the outer wall 24 has a first lateral side 26, a second lateral side 28, a front side 30 and a back side 32. The top end 20 is open to define the entry 14 and the bottom end 22 is open to define the exit 16.

Each of the first lateral side 26 and the second lateral side 28 slopes downwardly between the front side 30 and the back side 32 at the top end 20 such that the entry 14 is oriented at a substantially diagonal angle with the outer wall 24. In this way the entry 14 can pass a maximum amount of sunlight 18 into the box 12. The back side 32 of the outer wall 24 has an angled portion 34 that is spaced from the bottom end 22 such that the bottom end 22 lies on a plane that is oriented at a substantially diagonal angle with the front side 30 of the outer wall 24. The back side 32 is mountable to a vertical support surface 36 such that the bottom end 22 is directed away from the vertical support surface 36. The vertical support surface 36 may be an exterior wall of a building or other similar edifice that could potentially obstruct sunlight 18.

A first mirror 38 is provided and the first mirror 38 is positioned within the box 12. The first mirror 38 is comprised of a light reflecting material to reflect the sunlight 18 that passes into the box 12. The first mirror 38 has a first surface 40 and a second surface 42, and the first surface 40 is attached to an inside surface 44 of the outer wall 24 of the box 12. The first mirror 38 is positioned on the back side 32 of the outer wall 24 and the first mirror 38 extends between the top end 20 and the angled portion 34 of the back side 32 of the outer wall 24.

A second mirror 46 is provided and the second mirror 46 is positioned within the box 12. The second mirror 46 is comprised of a light reflecting material to reflect the sunlight 18 that passes into the box 12. The second mirror 46 is positioned on an opposite side of the box 12 with respect to the first mirror 38. In this way each of the first mirror 38 and the second mirror 46 can direct the sunlight 18 that passes into the entry 14 outwardly through the exit 16. Thus, the sunlight 18 which passes through the exit 16 can be directed toward a solar panel 47. The second mirror 46 has a primary surface 48 and a secondary surface 50, and the primary surface 48 is attached to the inside surface 44 of the outer wall 24 of the box 12. The second mirror 46 is positioned on the front side 30 of the outer wall 24. Additionally, the second mirror 46 is aligned with the first mirror 38 with respect to positioning between the top end 20 and the bottom end 22 of the box 12.

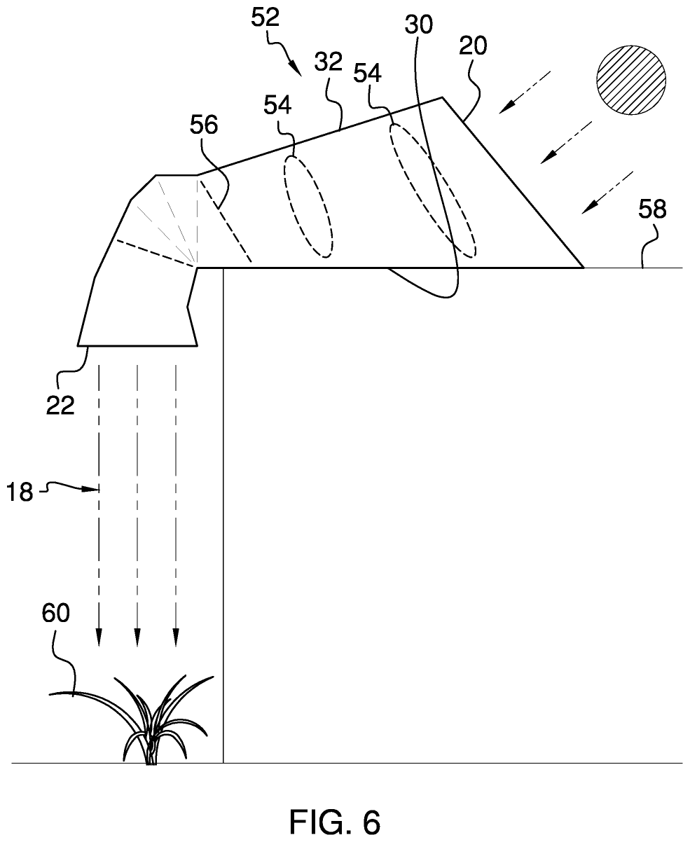

In an alternative embodiment 52 as is most clearly shown in FIG. 6, the front side 30 and the back side 32 of the outer wall 24 angle away from each other between the top end 20 and the angled portion 34 such that the top end 20 has a width is greater than the width of the bottom end 22. A plurality of lenses 54 is each positioned within the box 12 to magnify the sunlight 18 passing into the box 12. The lenses 54 are spaced apart from each other and are distributed between the top end 20 and the angled portion 34 of the outer wall 24. A prism refractor 56 is positioned within the box 12 and the prism refractor 56 is aligned with the angled portion 34 of the back side 32 of the outer wall 24. In this way the prism refractor 56 can refract the sunlight 18 that is magnified by the lenses 54 thereby directing the refracted sunlight 18 outwardly through the bottom end 22. The front side 30 of the outer wall 24 can be mounted to a horizontal support surface 58 such that the bottom end 22 is directed toward a target 60, such as a plant, that is intended to receive the sunlight 18.

In use, the back side 32 of the outer wall 24 of the box 12 is mounted to the vertical support surface 36, such as the exterior wall of the building, such that the bottom end 22 of the box 12 is directed toward the solar panel 47 and the top end 20 of the box 12 is exposed to sunlight 18. Sunlight 18 enters into the top end 20 of the box 12 and each of the first mirror 38 and the second mirror 46 reflect the sunlight 18 outwardly through the bottom end 22 of the box 12. In this way the bottom end 22 of the box 12 directs the sunlight 18 onto the solar panel 47. Thus, the solar panel 47 can receive the sunlight 18 when the building might otherwise block the sunlight 18 from striking the solar panel 47. In this way the solar panel 47 can receive full sunlight 18 during winter months, for example, in order to facilitate the solar panel 47 to operate at full capacity year round.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

1. A sunlight reflecting assembly for directing sunlight onto a solar panel to ensure the solar panel is continually exposed to sunlight, said assembly comprising:
a box having an entry and an exit, said exit being oriented at a substantially diagonal angle with said entry, said box being positionable outdoors wherein said entry is configured to have sunlight pass therethrough, wherein said box has a top end, a bottom end and an outer wall extending between said top end and said bottom end, said outer wall having a first lateral side, a second lateral side, a front side and a back side, said top end being open to define said entry, said bottom end being open to define said exit, each of said first lateral side and said second lateral side sloping downwardly between said front side and said back side at said top end such that said entry is oriented at a substantially diagonal angle with said outer wall wherein said entry is configured to pass sunlight into said box, wherein said back side of said outer wall has an angled portion being spaced from said bottom end such that said bottom end lies on a plane being oriented at a substantially diagonal angle with said front side of said outer wall, said back side being mountable to a vertical support surface such that said bottom end is directed away from said vertical support surface and opens in a direction opposite from said entry;
a first mirror being positioned within said box, said first mirror being comprised of a light reflecting material wherein said first mirror is configured to reflect the sunlight that passes into said box; and
a second mirror being positioned within said box, said second mirror being comprised of a light reflecting material wherein said second mirror is configured to reflect the sunlight that passes into said box, said second mirror being positioned on an opposite side of said box with respect to said first mirror wherein each of said first mirror and said second mirror is configured to direct the sunlight that passes into said entry outwardly through said exit thereby facilitating the sunlight which passes through said exit to be directed toward a solar panel.

2. (canceled)

3. The assembly according to claim 1, wherein said first mirror having a first surface and a second surface, said first surface being attached to an inside surface of said outer wall of said box, said first mirror being positioned on said back side of said outer wall, said first mirror extending between said top end and said angled portion of said back side of said outer wall.

4. The assembly according to claim 1, wherein said second mirror has a primary surface and a secondary surface, said primary surface being attached to an inside surface of said outer wall of said box, said second mirror being positioned on said front side of said outer wall, said second mirror being aligned with said first mirror with respect to positioning between said top end and said bottom end of said box.

5. A sunlight reflecting assembly for directing sunlight onto a solar panel to ensure the solar panel is continually exposed to sunlight, said assembly comprising:
a box having an entry and an exit, said exit being oriented at a substantially diagonal angle with said entry, said box being positionable outdoors wherein said entry is configured to have sunlight pass therethrough, said box having a top end, a bottom end and an outer wall extending between said top end and said bottom end, said outer wall having a first lateral side, a second lateral side, a front side and a back side, said top end being open to define said entry, said bottom end being open to define said exit, each of said first lateral side and said second lateral side sloping downwardly between said front side and said back side at said top end such that said entry is oriented at a substantially diagonal angle with said outer wall wherein said entry is configured to pass sunlight into said box, said back side of said outer wall having an angled portion being spaced from said bottom end such that said bottom end lies on a plane being oriented at a substantially diagonal angle with said front side of said outer wall, said back side being mountable to a vertical support surface such that said bottom end is directed away from said vertical support surface and opens in a direction opposite from said entry;
a first mirror being positioned within said box, said first mirror being comprised of a light reflecting material wherein said first mirror is configured to reflect the sunlight that passes into said box, said first mirror having a first surface and a second surface, said first surface being attached to an inside surface of said outer wall of said box, said first mirror being positioned on said back side of said outer wall, said first mirror extending between said top end and said angled portion of said back side of said outer wall; and
a second mirror being positioned within said box, said second mirror being comprised of a light reflecting material wherein said second mirror is configured to reflect the sunlight that passes into said box, said second mirror being positioned on an opposite side of said box with respect to said first mirror wherein each of said first mirror and said second mirror is configured to direct the sunlight that passes into said entry outwardly through said exit thereby facilitating the sunlight which passes through said exit to be directed toward a solar panel, said second mirror having a primary surface and a secondary surface, said primary surface being attached to an inside surface of said outer wall of said box, said second mirror being positioned on said front side of said outer wall, said second mirror being aligned with said first mirror with respect to positioning between said top end and said bottom end of said box.

6. The assembly according to claim 5, wherein said front side and said back side of said outer wall angle away from each other between said top end and said angled portion such that said top end has a width being greater than the width of said bottom end.

7. The assembly according to claim 6, further comprising a plurality of lenses, each of said lenses being positioned within said box wherein each of said lenses is configured to magnify the sunlight passing into said box, said lenses being spaced apart from each other and being distributed between said top end and said angled portion of said outer wall.

8. The assembly according to claim 7, further comprising prism refractor being positioned within said box, said prism refractor being aligned with said angled portion of said back side of said outer wall wherein said prism refractor is configured to refract the sunlight that is magnified by said lenses thereby directing the refracted sunlight outwardly through said bottom end.

9. A sunlight reflecting system for directing sunlight onto a solar panel to ensure the solar panel is continually exposed to sunlight, said assembly comprising:
a solar panel being positioned adjacent to a structure;
a box having an entry and an exit, said exit being oriented at a substantially diagonal angle with said entry, said box being positionable outdoors wherein said entry is configured to have sunlight pass therethrough, said box having a top end, a bottom end and an outer wall extending between said top end and said bottom end, said outer wall having a first lateral side, a second lateral side, a front side and a back side, said top end being open to define said entry, said bottom end being open to define said exit, each of said first lateral side and said second lateral side sloping downwardly between said front side and said back side at said top end such that said entry is oriented at a substantially diagonal angle with said outer wall wherein said entry is configured to pass sunlight into said box, said back side of said outer wall having an angled portion being spaced from said bottom end such that said bottom end lies on a plane being oriented at a substantially diagonal angle with said front side of said outer wall and opens in a direction opposite from said entry, said back side being mountable to the structure such that said bottom end is directed toward said solar panel;
a first mirror being positioned within said box, said first mirror being comprised of a light reflecting material wherein said first mirror is configured to reflect the sunlight that passes into said box, said first mirror having a first surface and a second surface, said first surface being attached to an inside surface of said outer wall of said box, said first mirror being positioned on said back side of said outer wall, said first mirror extending between said top end and said angled portion of said back side of said outer wall; and
a second mirror being positioned within said box, said second mirror being comprised of a light reflecting mirror wherein said second mirror is configured to reflect the sunlight that passes into said box, said second mirror being positioned on an opposite side of said box with respect to said first mirror wherein each of said first mirror and said second mirror is configured to direct the sunlight that passes into said entry outwardly through said exit thereby facilitating the sunlight which passes through said exit to be directed toward said solar panel, said second mirror having a primary surface and a secondary surface, said primary surface being attached to an inside surface of said outer wall of said box, said second mirror being positioned on said front side of said outer wall, said second mirror being aligned with said first mirror with respect to positioning between said top end and said bottom end of said box.
